(19) United States
(12) Patent Application Publication
(10) Pub. No.: US 2006/0070655 A1
(43) Pub. Date: Apr. 6, 2006

(54) Valve

(75) Inventor: Stephen Walker Tebby, Warwickshire (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: DUNLOP AEROSPACE LIMITED, Weat Midlands (GB)

(21) Appl. No.: 10/534,619

(22) PCT Filed: Nov. 12, 2003
(86) PCT No.: PCT/GB03/04914

§ 371 Date: May 11, 2005

(30) Foreign Application Priority Data
Nov. 12, 2002 (GB) 0226349.9
Oct. 3, 2003 (GB) 0323182.6

(51) Int. Cl. G05D 11/00

(52) U.S. Cl. 137/112

(57) ABSTRACT

A valve body comprises two inlet ports for receiving fluid at respective different pressures, an outlet port for delivering said fluid, a valve member mounted for limited movement within said body, and biasing means for biasing said valve member to move to one limit of its movement, said valve member being operable to move in response to the difference in pressure at said first and second ports in response to said biasing means for causing the valve member to vary the respective contributions of fluid delivered to the outlet port from the inlet ports. The valve body can contain a further movable valve member which is operable for receiving fluid from isolating control means and, in response thereto, for moving to obstructions one of said inlet ports and for urging the first mentioned valve member to obstruct the other inlet port.

This invention relates to a valve, more particularly but not exclusively, an air bleed valve for an aircraft gas turbine engine. In the field of gas turbine engines for aircraft, there is frequently a requirement to bleed off compressor air for service purposes such as anti-icing flow. At low engine speeds, the pressure developed by a low pressure stage may be insufficient to provide the flow rate required for such purposes. An adequate flow rate may only be satisfied by the higher pressure stages, e.g. from the second of two stages or the 3rd of 3 or the 7th of 10 and so on. At higher engine speeds, however, both the pressure and the air temperature from the same stage may be too high thereby producing a flow rate which is excessive to requirements.

Adequate quantities of bleed air at appropriately lower temperatures at higher engine speeds can typically be obtained from a low pressure compressor stage, e.g, the first of two or three or the third of ten and so on.

When the requirement is for a substantially constant mass flow rate of air to be provided for anti-icing purposes throughout the entire engine speed range, a common method is to adopt two separate valves, one receiving bleed air from a lower pressure compressor stage and the other from a higher pressure stage. The valve receiving air from the lower pressure stage progressively opens with increasing engine speed (since compressor pressure rises with engine speed), until it is fully open at rated engine speed. The valve receiving air from the higher pressure stage typically may progressively close from a fully open position at engine idling speed to a fully closed position at engine rated speed. Each valve may operate independently from the other, any final mixing occurring just prior to delivery to the anti-icing air distribution ducts.

Alternatively, only one valve may be provided which may operate in conjunction with a pressure regulator.

Valves used in this technology are of the type where the valve element is moved by the pressure of a fluid. Fluid from the higher pressure side of the valve is substantially prevented from leaking to the lower pressure side by the fitting of dry running carbon seals. Alternatively, leakage is completely prevented by use of rolling diaphragms. When bleed air temperatures exceed a certain level, rolling diaphragms cannot be used

It will be appreciated that air drawn through a gas turbine compressor may be heavily contaminated with sand and grit particles ranging in size between may be 1 mm across down to fine dry or sticky dust particles one-hundredth of a millimetre across or less.

The current systems described above may typically suffer from two main drawbacks.

Firstly, where valve pistons operate within closely fitting bores, the dry-running piston seals are prone to sticking and jamming due to the constant throughput and building up of contamination.

Secondly, owing to the pressure difference across a valve piston seal commonly used in this technology field, there arises a frictional resistance to the movement of the valve piston which in turn causes the characteristic stick-slip motion typical of this type of sealing arrangement. The frictional resistance to movement is usually proportional to the pressure difference across the seal. The effect of the stick-slip is to reduce the resolution of the valve. i.e. to impair the sensitivity of the response of the valve to a small change in engine speed. A reduction in valve resolution can lead to a valve giving a mass flow performance characteristic outside its required tolerance range.

One object of the present invention is to provide a valve which does not require close valve piston-bore clearances or nominally low-leakage dry running seals. Consequently there are no significant frictional loads opposing the modulating action and no close clearances vulnerable to contamination blockage. A further object is to provide a valve usable under conditions where bleed air temperatures are too high to enable rolling diaphragms to give a satisfactory service life.

According to one aspect of the invention, there is provided a valve having a valve body, two inlet ports for receiving fluid at respective different pressures, an outlet port for delivering said fluid, a valve member mounted for limited movement within said body, and biasing means for biasing said valve member to move to one limit of its movement, said valve member being operable to move in response to the difference in pressure at said first and second ports and in response to said biasing means for causing the valve member to vary the respective contributions of fluid delivered to the outlet port from the inlet ports.

Advantageously, the valve body contains a further movable valve member which is operable for receiving fluid from isolating control means and, in response thereto, for moving to obstructing one of said inlet ports and for urging the first mentioned valve member to obstruct the other inlet port.

Preferably, said valve members are movable relative to one another and to said valve body in directions aligned with the same axis extending through the valve body.

Advantageously, the first-mentioned valve member is journalled for movement on a spindle fixed to the further valve member and extending in the direction of said axis.

Said biasing means may be a compression spring.

The compression spring is preferably engaged between said first-mentioned valve member and a spring engaging member fixed with respect to the further valve member.

Advantageously, the valve body comprises portions defining first, second and third valve seating surfaces, said first-mentioned valve member comprising oppositely directed surfaces for engaging respective ones of said first and second seating surfaces for obstructing respective ones of said inlet ports, and said further valve member comprising a surface for engaging said third seating surface for causing both inlet ports to become obstructed.

Preferably, one or both of the first and second valve seating surfaces is shaped for forming high clearance contact with the respective valve member surface.

One or both of the first and second valve seating surfaces may comprise apertures, for example slots, for causing a desired variation in fluid flow through the gap between the valve seating surface and the valve member surface.

According to a second aspect of the invention, there is provided a valve having a valve body and a valve member comprising respective seating surfaces for moving one with respect to another to control the flow of fluid through the valve, one or both of said surfaces comprising apertures, for example slots, for causing a desired variation in fluid flow as the seating surfaces move as aforesaid.

According to a third aspect of the present invention a valve incorporates a valve modulating element. It is provided with two flow inputs, one from a high pressure compressor stage, the second from a low pressure compressor stage. Both flow sources exhibit a rising pressure characteristic with an increase in engine speed. At engine idling speed, the valve element is urged by a spring to a position which permits full service flow from the high pressure source to a service duct and substantially zero flow from the low pressure source to the service duct. As engine speed increases, an increasing pressure differential across the valve element develops thereby causing the valve element to move against the spring and to begin to permit flow from the low pressure source to the service duct. At the same time, the flow area which is allowing flow from the high pressure source to the service duct begins to decrease. As engine speed rises further, flow from the high pressure source is progressively shut off whilst flow from the low pressure source increases until at engine rated speed, or other predetermined engine speed, the flow from the high pressure source is substantially cut off and flow from the low pressure source attains its full rated flow through to the service duct.

The flow profiles of the valve element are arranged to give the desired flow throughput with increasing engine speed between the extremes of firstly, full service flow from the high pressure source to the service duct and no flow from the low pressure source to the service duct and, secondly, no flow from the high pressure source to the service duct and full flow from the low pressure source to the service duct.

For a better understanding of the invention and to show how the same may be carried into effect, reference will now be made, by way of example, to the accompanying drawings, in which:

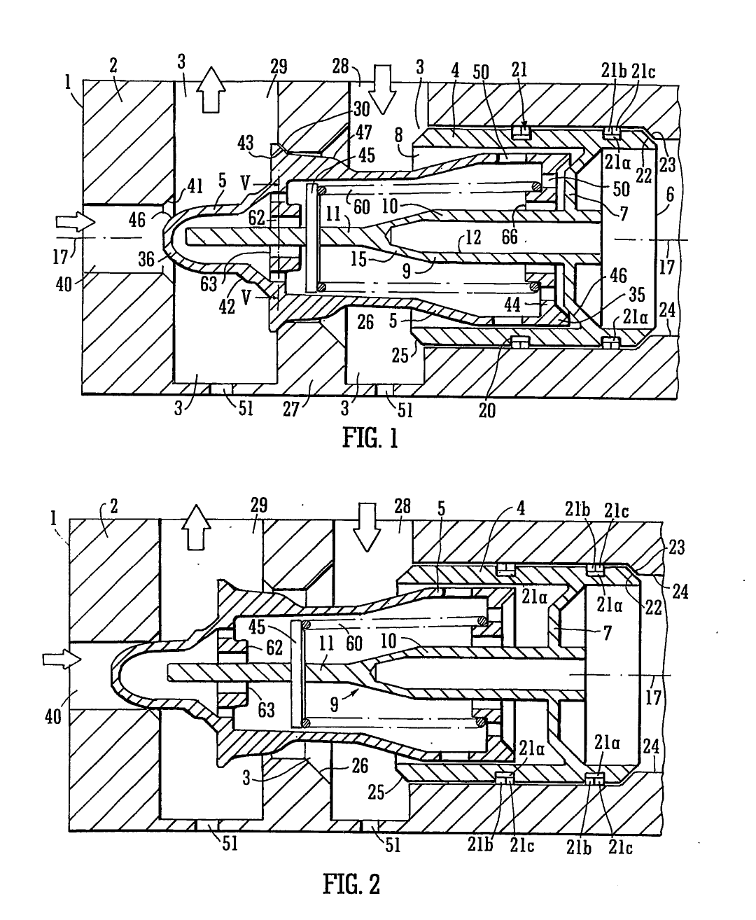

FIG. 1 is a sectional elevation of a valve for receiving air from lower and higher pressure compressor stages of a gas turbine engine and delivering such air to an outlet port, the valve being in a first state;

FIGS. 2, 3 and 4 correspond to FIG. 1 but showing the valve in second, third and fourth states respectively;

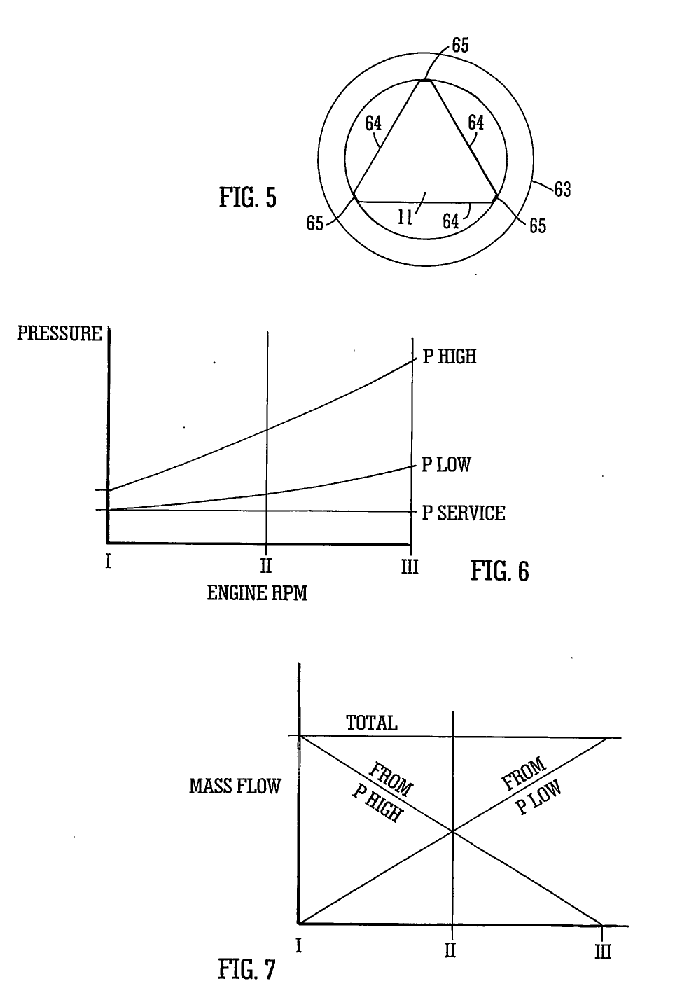

FIG. 5 is a section on the line VV in FIG. 1;

FIG. 6 is a graph illustrating the variation of engine speed with air pressure from the lower and higher pressure compressor stages and the desired service pressure at the outlet port; and

FIG. 7 is a graph illustrating a substantially constant mass flow of air available at the outlet port as engine speed varies, and the respective contributions of the mass flow from the two compressor stages.

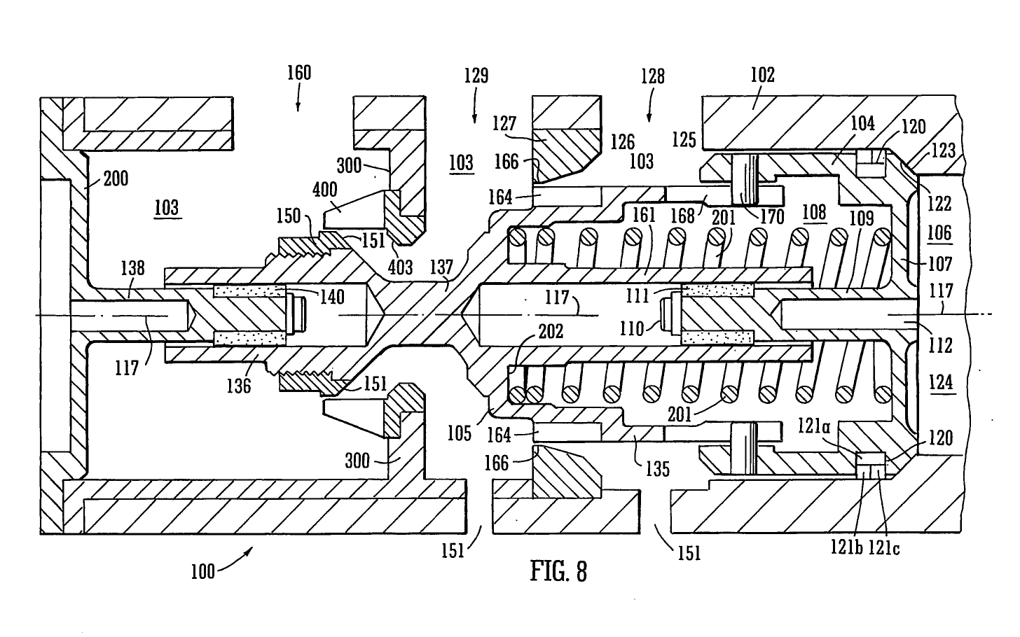

FIG. 8 is a sectional elevation of another valve;

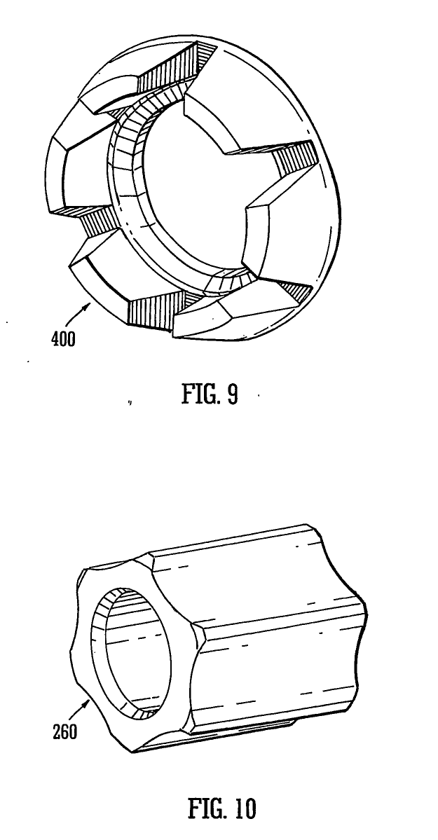

FIG. 9 is a perspective view of a valve aperture control member used in the FIG. 8 valve, and

FIG. 10 is a perspective view of a bearing bush used in the FIG. 8 valve.

The valve 1 of FIG. 1 to 5 comprises a valve body 2 bounding a generally-cylindrical hollow space 3 in which there are two movable valve members 4 and 5.

The valve member 4 is generally cylindrical and hollow. Near one end 6, there is a partition 7 extending across the cylindrical space 8 within the valve member and supporting a spindle 9. Spindle 9 extends through space 3 and is aligned along the axis 17 thereof. It has first and second portions 10 and 11 of about equal length with the portion 10 being nearer the partition 7. This portion 10 has an outside diameter greater than that of portion 11 and it has a bore 12 formed therein, the bore extending right along the portion 10 from the end near partition 7. Portions 10 and 11 merge one with the other via a short tapered section 15.

The valve member 4 is slidably movable within the space 3 and it has two spaced circumferential slots 20 in each of which there is a sealing ring 21. Preferably, the sealing ring is made of carbon and is a composite ring comprising a split ring 21a and two side-by-side spit rings 21b and 21c between ring 21a and the wall of space 3.

The rear corner end face 22 of valve member 4 is tapered and is engageable with a matching seating surface 23 at which the space 3 merges with a gas port 24. The front corner end face 25 of valve member 4 is also tapered and is able to engage a seating surface 26 defined in a partition section 27 of the space 3 between two further gas ports 28 and 29 respectively. Ports 28 and 29 extend transversely away from the axis 17 and communicate with space 3. The other side, i.e. the port 29 side of partition section 27 also has a tapered seating surface 30.

Within the space 3, partially engaged within the valve member 4, there is the other movable valve member, i.e. the member 5. Member 5 has a rear section 35 which is generally spool shaped and a bullet shaped front portion 36.

The bullet-shaped portion faces a further port 40 which merges with space 3 via a further tapered seating 41 which matches an engaging portion 42 at the base of the bullet-shaped portion.

The rear facing corner 43 of the front of the spool-shaped section of the valve member 5 is tapered so as to be able to engage the seating.

In addition, within the spool shaped portion of the valve member 5, there is a compression spring 60 which is engaged between the rear wall 44 of the valve member 5 and an annular plate 45 fixed to the spindle part 11. The outside of the rear wall 44 is shaped to match the front face 46 of partition 7.

Ports 40 and 28 are coupled to the higher and lower pressure respectively of two compressor stages of a gas turbine engine (not shown). Port 29 is an outlet for service air purposes for example to the ant-icing system of the aircraft (not shown). Port 24 is connected to a source of high pressure air, for example the aforementioned higher pressure compressor stage, via an isolating controller valve (not shown).

The interior of the valve 5 communicates with space 3 via opening 50. Ports 28 and 29 may have drain ports 51.

Initially, as shown in FIG. 1, the engine is running at relatively low speed. The valve is in its rearward position, i.e. to the right in the figure, so that the high pressure stage port 40 is open to the space 3 and to the outlet port 29. The seating is closed by the valve surface at corner 43 so as to seal the lower pressure compressor stage port form the valve.

As the engine speed increases, the pressure of the air from the lower pressure compressor stage builds up in the interior of the valve member 5 and drives it forward to an intermediate valve state shown in FIG. 2. Here, air is received and passed to outlet port 29 from both compressor stages. As the engine speed continues to rise, the valve member 5 is driven further forward so that port 40 is closed off and the service air supply is delivered from the low pressure stage alone.

At any stage shown in FIGS. 1 to 3, air can be delivered via the isolator control to port 24. This drives the valve member 4 forward as shown in FIG. 4, i.e. to the left of the position shown in each of FIGS. 1, 2 and 3, so that its front seating face engages the seating 26 in partition 27 and closes port 28. At the same time, the valve member 5 is driven forward by the front face 46 of the partition 7 of the valve member 4 to close off port 40.

FIG. 5 shows a cross-section W of a journal 62 and a bearing 63. The journal and bearing provide radial location for valve member 5 on spindle portion 11. The spindle portion 11 has a cross-section which has three equi-spaced longitudinal flats 64, i.e. so it is generally triangular but with the corners truncated to define curved bearing surfaces 65 matching the internal surface of bearing 63. Alternatively, instead of the flats 64 of the triangular spindle portion 11, the spindle portion 11 could have longitudinal grooves (not shown). The flats 64 or grooves (not shown) reduce the area of spindle portion 11 in contact with the inside surface of bearing 63 and their purpose is to improve the bearing's resistance to blockage and contamination.

Similarly, a bearing 66 is provided in the rear wall 44 of valve member 5 and the second portion 10 of spindle 9 is engaged in this bearing. The second portion 10 of spindle 9 has a cross-section defining flats or grooves the same as portion 11, i.e. the second portion 10 is also as shown in FIG. 5.

FIG. 6 shows a graph of variation with engine speed of air pressure P from the lower and higher pressure compressor stages P_{L} and P_{H} respectively and the desired service pressure P_{S} at the outlet port 29. The Roman numerals along the abscissa of FIG. 6 (and in FIG. 7 to be referred to later) mark values of engine speed when the valve member 5 is in the positions shown in FIGS. 1, 2 and 3 respectively.

It will be appreciated that instead of being as shown in FIG. 6, it may be preferred for the service pressure requirement to rise with increasing engine speed in which case the valve flow areas between seating 41 and engaging portion 42 and between seating surface 30 and rear facing tapered corner 43 may be proportionately modified accordingly.

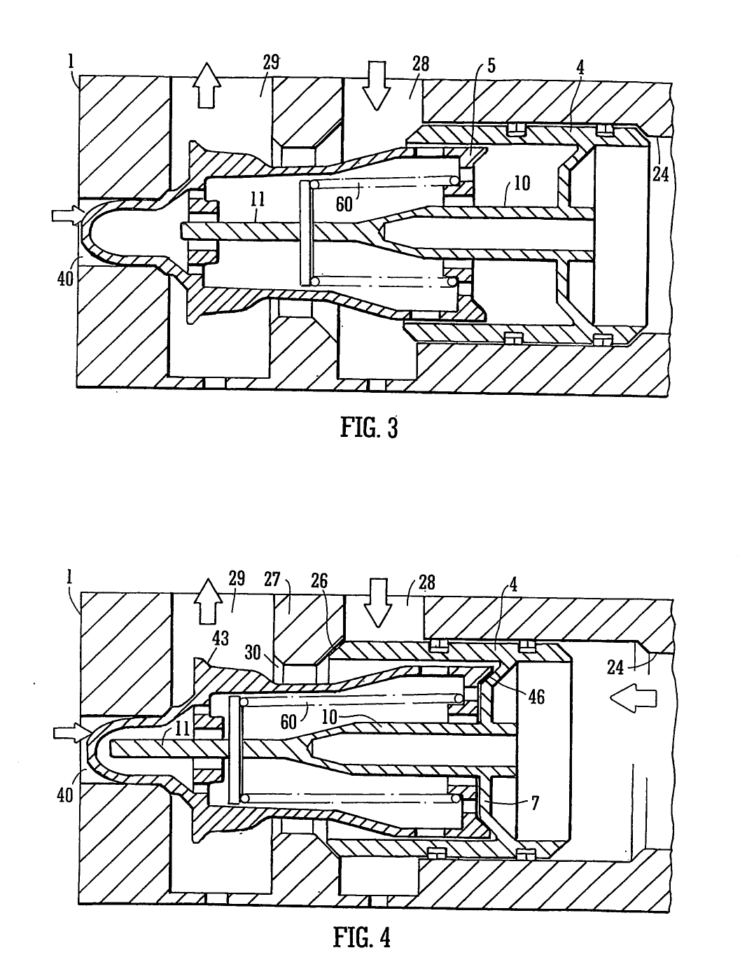

FIG. 7 shows a graph illustrating a substantially constant total mass flow of air MT available at the outlet port 29 as engine speed varies and the respective contributions of the mass flow MP_{L} and MP_{H} from the two compressor stages. It will be appreciated that the relative contributions of mass flows through ports 28 and 40 may be adjusted by appropriate detailed modifications to the profiles 46 and 47. Further, it will be appreciated that a desired change from a constant mass flow rate available at the outlet port 29 with increasing engine speed to an increasing mass flow rate with increasing engine speed may be effected for example by increasing the flow area between the seating 30 and the rear facing tapered corner 43 when the valve is at a position corresponding to that illustrated in FIG. 3.

The valve 100 of FIGS. 8 to 10 again comprises a valve body 102 bounding a generally cylindrical hollow space 103 in which there are two movable valve members 104 and 105.

The valve member 104 is generally cylindrical and hollow. At one end 106, there is a partition 107 extending across the cylindrical space 108 within the valve member and supporting a spindle 109. Spindle 109 extends through space 108 and is aligned along the axis 117 thereof. It extends to a position slightly outward from the space 108 and, near its outer end 110, it carries a bearing bush 111. To reduce weight, spindle 109 has a central bore 112 formed therein, the bore extending about half way along the spindle 109 from partition 107.

The valve member 104 is slidably movable within the space 103 and it has a circumferential slot 120 in which there is a sealing ring 121. Preferably, the sealing ring 121 is like the sealing ring 21 of FIGS. 1 to 5, i.e. it is made of carbon and is a composite ring comprising an inner split ring 121a and two outer side-by-side spit rings 121b and 121c between the inner ring 121a and the wall of space 103.

The rear corner end face 122 of valve member 104 is tapered and is engageable with a matching seating surface 123 at which the space 103 merges with a gas port 124. The front corner end face 125 of valve member 104 is also tapered and is able to engage a seating surface 126 defined in a partition section 127 of the space 103 between two further gas ports 128 and 129 respectively. Ports 128 and 129 extend transversely away from the axis 117 and communicate with space 103.

Within the space 103, there is the other movable valve member, i.e. the member 105. Member 105 has a rear portion 135 and a front portion 136, both of which are hollow. They are connected to each other by a relatively narrow neck 137.

The front portion 136 is open towards the front of the valve and is there engaged over a further spindle 138 that extends back from the front wall 200 of the valve. The spindle 138 has a bearing bush 140 thereon. The bearing bush is in sliding contact with the internal wall of portion 136.

A further air entry port 160 is provided in the valve wall adjacent the front portion 136 of the valve member 105.

At the rear facing corner portion 143 of the front portion of the valve member 105, there is a bearing bush 150 with a rear facing bevelled end 151. This tapered corner portion 143 can be integral with the valve member or it can be a separated sleeve shaped member as shown.

Between the end wall 200 and the partition 127, there is a further partition 300 with coaxial hole in which there is fitted a valve aperture control member 400 best shown in FIG. 9. Member 400 has a front section 401 which is inwardly tapered and has an array of slots 402 open towards the front of the valve. In the drawings the slots 402 have inclined walls so the slots get wider towards the front of the valve. However, the walls of the slots could instead be parallel or incline in the opposite direction, i.e. the slots could become narrower towards the front of the valve. The slot shape is chosen in dependence upon the required relationship between pressure, pressure drop, mass flow and axial position of the valve modulating element 105. The member 400 also has a bevelled seating surface 403 facing and engageable with the end 151 of bush 150. When the front portion 136 of the valve member 105 moves from a forward position back towards the rear of the valve, bush 150 becomes engaged to an increasing degree with the slotted section of the member 400 so as to form an increasing obstruction for flow of air between port 160 and port 129. The slots are shaped to give a desired control curve. Eventually the bevelled edge 151 engages seat 403 to substantially close the aperture.

The rear portion 135 of valve member 105 opens to the space within the valve member 104. There is a hollow spindle 161 within portion 135. This spindle extends rearwardly from the forward end of the portion 135 and is engaged on the bearing bush 111 on spindle 109. Near the front of the portion 135, the exterior of the portion 135 is stepped down in diameter to receive a bush 164 which is in precision or loose sliding contact within a bore 166 adjacent the seating surface 126 in partition 127.

Rear portion 135 of valve member 105 has a plurality of longitudinal slots 168 with which there are engaged a matching plurality of dowel pegs 170 fixed to valve member 104. These couple the two valve members 104 and 105 together while allowing limited relative movement parallel to the axis 117 of the space 103.

In addition, within the hollow rear portion 135 of the valve member 105, there is a compression spring 201 which is engaged between the front wall 202 of the rear portion 135 of the valve member and the rear wall 107 of valve member 104.

Ports 160 and 128 are coupled to the higher and lower pressure respectively of two compressor stages of a gas turbine engine (not shown). Port 129 is an outlet for service air purposes for example to the ant-icing system of the aircraft (not shown). Port 124 is connected to a source of high pressure air, for example the aforementioned higher pressure compressor stage, via an isolating controller valve (not shown).

Beneath ports 128 and 129 there may be respective drain ports 151.

At the front of the rear section 135 of the valve member 105 just to the rear of neck 137, there is a bevelled surface 250 which can engage a corresponding bevelled surface 252 at the rear side of member 400.

Initially, as shown in FIG. 8, the engine is running at relatively low speed. The valve member 104 is in its rearward position, i.e. to the right in the figure to close port 124. The valve member 105 is in its forward position so that the high pressure stage port is open to the space 103 and to the outlet port 129. The presence of the bush 164 obstructs flow between the ports 128 and 129 so as to substantially close the lower pressure compressor stage from the valve.

As the engine speed increases, the pressure of the air from the lower pressure compressor stage builds up in the interior of the valve member 105. Then because of the different relative sizes of the front and rear portions of the valve member 105, the valve member 105 is driven rearward to an intermediate valve state. Here, air is received and passed to outlet port 129 from both compressor stages, i.e. some air from port 160 passes via the slots in member 400 and some air from port 128 is flowable to past the gap between surface 166 and bush 164. As the engine speed continues to rise, the valve member 105 is driven further rearward so that port 160 is closed off and the service air supply is delivered from the low pressure stage alone.

At any stage shown in FIGS. 8 to 10, air can be delivered via the isolator control to port 124. This drives the valve member 104 forward, i.e. to the left of the position shown, so that its front seating face 125 engages the seating 126 in partition 127 and closes port 128. At the same time, the valve member 105 is driven forward by the spring 201. The dowel pegs 170 act to limit the travel of the valve member 105 in the leftward (forward) direction under the thrust of the spring 201. Meanwhile the pressure applied via port 124 is admitted via the outer edge face of the rightmost end of the portion 135 of the valve member 105 through to the bevelled seating surfaces 250 and 252. This tends to reduce or avoid shock loads applied to the dowel pegs 170.

Bushes 111 and 140 are identical. FIG. 9 shows a perspective view of one of them. Each spindle is cylindrical but the outside surface 260 of the bush has a plurality of equi-spaced curved relieved portions 270 extending in the direction of its axis. Between the relieved portion 270, there are defined curved bearing surfaces 280 matching the internal surface of spindle 136 or 161. The relieved portions have the purpose of improving resistance to blockage and contamination.

The internal surfaces of the spindles 136 and 161 may each comprise one or more circumferential, square-edged grooves (not shown) that give a scraping action to the periphery of the contacting surfaces 280 of the respective bush 260. This resists contamination or blockage that may build up on the bushes.

The spindle bearings using bushes 111 and 140 could be used in the embodiment of FIGS. 1 to 7. The valve aperture control member 400 could also be adapted and used in the FIG. 1 to 7 embodiment instead of plain seatings. Instead of bush 164 engaged in bore 166, there could be used bevelled seatings as elsewhere.

In FIG. 4 of the drawings, the front portion 136 of the valve member 105 contains a central bore engaged on the bush 140 mounted on spindle 138. As an alternative (not shown), the hollow front portion 136 could be replaced by a spindle member engaged in a hollow member that replaces the spindle 138, i.e. the arrangement of items 136 and 138 could be reversed. A bush similar to the bush 140 could be provided either on the spindle or the hollow member to give good sliding contact between the spindle and hollow member as before.

A similar modification may be made in respect of the spindle 109, bearing bush 111 and hollow spindle 161. Thus, the bore within spindle 161 could be omitted, and the spindle 109 made hollow up to its front end so that, with the dimensions of the items appropriately changed, spindle 109 can receive spindle 161, preferably with a bearing bush such as 111 provided on one or the other spindle. The bore 12 could be closed at the rear end of the valve.

1. A valve having a valve body, first and second inlet ports for receiving fluid at respective different pressures, an outlet port for delivering said fluid, a valve member mounted for limited movement within said body, and biasing means for biasing said valve member to move to one limit of its movement, said valve member being operable to move in response to the difference in pressure at said first and second ports and in response to said biasing means for causing the valve member to vary the respective contributions of fluid delivered to the outlet port from the inlet ports.

2. A valve according to claim 1, wherein the valve body contains a further movable valve member which is operable for receiving fluid from isolating control means and, in response thereto, for moving to close off one of said inlet ports and for urging the first mentioned valve member to close off the other inlet port.

3. A valve according to claim 2, wherein said valve member and said further movable valve member are movable relative to one another and to said valve body in directions aligned with the same axis extending through the valve body.

4. A valve according to claim 2, wherein the said valve member is journalled for movement on a spindle fixed to the said further movable valve member and extending in the direction of said axis.

5. A valve according to claim 4, wherein said biasing means is a compression spring.

6. A valve according to claim 5, wherein said compression spring is engaged between said valve member and a spring engaging member fixed with respect to the said further movable valve member.

7. A valve according to claim 2, wherein the valve body comprises portions defining first, second and third valve seating surfaces, said valve member comprising oppositely directed surfaces for engaging respective ones of said first and second seating surfaces for closing respective ones of said inlet ports, and said further valve member comprising a surface for engaging said third seating surface for causing both inlet ports to become closed.

8. A valve according to claim 7, wherein one or both of the first and second valve seating surfaces is shaped for forming high clearance contact with the respective valve member surface.

9. A valve according to claim 7, wherein one or both of the first and second valve seating surfaces comprises apertures, for causing a desired variation in fluid flow through the gap between the valve seating surface and the valve member surface.

10. A valve having a valve body and a valve member comprising respective seating surfaces, the valve member being movable with respect to the valve body to control the flow of fluid through the valve, one or both of said surfaces comprising apertures, for causing a desired variation in fluid flow as the seating surfaces move as aforesaid.

11. A valve having a valve body and a valve member comprising respective seating surfaces for moving one with respect to another to control the flow of fluid through the valve, one or both of said surfaces comprising apertures for causing a desired variation in fluid flow as the seating surfaces move as aforesaid.
